(19) United States
(12) Patent Application Publication
(10) Pub. No.: US 2016/0134743 A1
(43) Pub. Date: May 12, 2016

(54) METHOD AND APPARATUS FOR MANAGING FUNCTION OF WEARABLE DEVICE

(71) Applicant: Samsung Electronics Co., Ltd., Suwon-si (KR)

(72) Inventors: Seong-Joon JEON, Yongin-si (KR); Na-Rae JO, Seoul (KR); Gyu-Seok SHIM, Suwon-si (KR); Ki-Soo CHO, Seoul (KR); In-Hyuk CHOI, Seoul (KR); Il-Sung HONG, Seoul (KR)

(21) Appl. No.: 14/936,089

(22) Filed: Nov. 9, 2015

(30) Foreign Application Priority Data
Nov. 12, 2014 (KR) 10-2014-0157049

(51) Int. Cl. H04M 1/725; H04W 76/04; H04W 4/00; H04B 1/3827; H04L 12/26

(52) U.S. Cl. CPC H04M 1/72569; H04B 1/385; H04L 43/065; H04W 4/005; H04W 76/046

(57) ABSTRACT

A wearable electronic device is provided. The wearable electronic device includes a wear-or-not of a user for the wearable electronic device and limit at least one linked function using data transmitted and received to and from another electronic device, when the determining of the wear-or-not is determined as a non-wear state.

### CROSS-REFERENCE TO RELATED APPLICATION(S)

This application claims the benefit under 35 U.S.C. §119(a) of a Korean patent application filed on Nov. 12, 2014 in the Korean Intellectual Property Office and assigned Serial number 10-2014-0157049, the entire disclosure of which is hereby incorporated by reference.

### TECHNICAL FIELD

The present disclosure relates to a method and a device for managing a function of a wearable device.

### BACKGROUND

A use of a portable electronic device, such as a smart phone has become common, and thus various wearable electronic devices which may be linked to the portable electronic device have been developed. The wearable electronic device is an electronic device implemented as a form directly worn by a user. For example, the wearable electronic device may include a Head-Mounted-Device (HMD), electronic clothing, an electronic bracelet, an electronic necklace, an electronic appcessory, an electronic tattoo and a smart watch.

The wearable electronic device satisfies various requirements of a user by providing improved function, which demonstrates a mutual synergy through a mobile communication terminal, for example, a smart electronic device having various functions.

For example, the wearable electronic device may include a heartbeat sensor, a temperature measuring sensor, a pulse measuring sensor, a sound wave sensor, an acceleration sensor and the like, to collect various bio information of a user. In addition, the wearable electronic device may transmit the collected bio information to a smart phone to provide a health management function to the user.

In addition, a part of a function of an application installed in the smart phone may be provided to the user through the wearable electronic device. In addition, when an e-mail or a message is received by the smart phone, or a telephone call is received, a notification related to this may be output through the wearable electronic device.

Since such linked functions are provided in a state in which the wearable electronic device and an electronic device are connected through a wireless communication, more power is consumed when a linked function is executed in the wearable electronic device than when a function is independently executed in the wearable electronic device.

The above information is presented as background information only to assist with an understanding of the present disclosure. No determination has been made, and no assertion is made, as to whether any of the above might be applicable as prior art with regard to the present disclosure.

### SUMMARY

However, although when a user does not wear the wearable electronic device, the wearable electronic device performs an operation according to the linked function. Therefore, unnecessary battery consumption may occur, and unnecessary noise may be generated according to a continuous execution of an alarm and synchronization.

Aspects of the present disclosure are to address at least the above-mentioned problems and/or disadvantages and to provide at least the advantages described below. Accordingly, an aspect of the present disclosure is to provide a method and a device capable of reducing battery consumption of a wearable electronic device.

Another aspect of the present disclosure is to provide a method and a device capable of reducing an unnecessary operation of a wearable electronic device.

Another aspect of the present disclosure is to provide a method and a device capable of reducing unnecessary battery consumption and operation of an electronic device, which is linked with a wearable electronic device.

In accordance with an aspect of the present disclosure, a method of managing a function of a wearable electronic device is provided. The method includes determining the wear-or-not of a user for the wearable electronic device, and limiting at least one linked function using data transmitted, and received to and from another electronic device, when the determining of the wear-or-not is determined as a non-wear state.

In accordance with another aspect of the present disclosure, a wearable electronic device is provided. The wearable electronic device includes at least one sensor, and a control unit configured to determine a wear-or-not of a user for the wearable electronic device, using a sensor value of the sensor, and to limit at least one linked function using data transmitted and received to and from another electronic device, when the determining of the wear-or-not is determined as a non-wear state.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a wearable electronic device and a main electronic device according to an embodiment of the present disclosure;

FIG. 2 is a view illustrating a construction of the wearable electronic device according to an embodiment of the present disclosure;

FIG. 3 is a view illustrating a network environment including an electronic device according to an embodiment of the present disclosure;

FIGS. 4 and 5 are views illustrating an operation process of the wearable electronic device according to various embodiments of the present disclosure;

FIG. 6 is a view illustrating an operation process of the main electronic device according to an embodiment of the present disclosure; and

FIGS. 7 and 8 are views illustrating operation processes of the wearable electronic device and the main electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expression “1”, “2”, “first”, or “second” used in various embodiments of the present disclosure may modify various components of various embodiments but does not limit the corresponding components. For example, the above expressions do not limit the sequence and/or importance of the corresponding elements. The expressions may be used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

In the present disclosure, the terms are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

An electronic device according to various embodiments of the present disclosure may be a wearable device having a structure which may be worn by a user. For example, the electronic device may include at least one of a Head-Mounted-Device (HMD), an electronic clothing, an electronic bracelet, an electronic necklace, an electronic appcessory, an electronic tattoo and a smart watch.

In addition, the electronic device according to various embodiments of the present disclosure may be an electronic device which provides a function linked with a wearable device by transmitting and receiving data to and from the wearable device through a communication. For example, the electronic device may include at least one of a smart phone, a tablet Personal Computer (PC), a mobile phone, a video phone, an e-book reader, a desktop PC, a laptop PC, a netbook computer, a PDA, a Portable Multimedia Player (PMP), a Moving Picture Experts Group (MPEG-1 or MPEG-2) Audio Layer III (MP3) player, a mobile medical device, a camera, a wearable device (e.g., a HMD such as electronic glasses, electronic clothes, an electronic bracelet, an electronic necklace, an electronic appcessory, an electronic tattoo, and a smart watch.

According to various embodiments of the present disclosure, the electronic device may be a smart home appliance. The smart home appliances may include at least one of, for example, televisions, digital video disk (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, or electronic frames.

According to various embodiments, the electronic device may include at least one of various types of medical devices (e.g., Magnetic Resonance Angiography (MRA), Magnetic Resonance Imaging (MRI), Computed Tomography (CT), a scanning machine, an ultrasonic wave device and the like), a navigation device, a Global Positioning System (GPS) receiver, an Event Data Recorder (EDR), a Flight Data Recorder (FDR), a car infotainment device, ship electronic equipment (e.g., navigation equipment for a ship, a gyro compass and the like), avionics, a security device, and an industrial or home robot.

According to various embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

According to an embodiment of the present disclosure, the wearable electronic device may determine a use-or-not for the wearable electronic device of a user according to a sensor value measured by at least one sensor in the wearable electronic device or a communication state with another electronic device. In addition, when it is determined that the user does not use the wearable electronic device (e.g., when the user does not wear the wearable electronic device or the user is in a sleep state), the wearable electronic device may limit at least one function or operation. In addition, a function or an operation of the other electronic device linked with the wearable electronic device as well as the function of the wearable electronic device may be limited by data transmission and reception through a communication.

For an understanding of such an embodiment, hereinafter, the wearable electronic device may be referred to as a wearable device and an electronic device linked with the wearable electronic device may be referred to as a main device.

Hereinafter, an electronic device according to various embodiments of the present disclosure will be described with reference to the accompanying drawings. In various embodiments, the term “user” may indicate a person using an electronic device or a device (e.g., an artificial intelligence electronic device) using an electronic device.

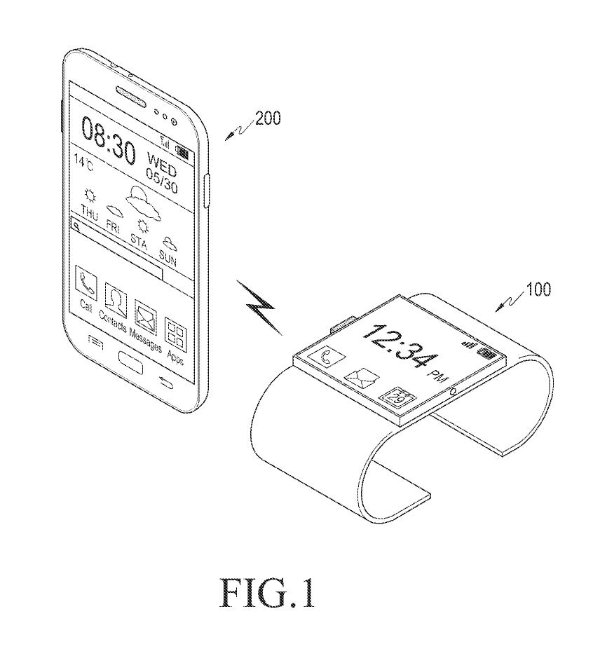

FIG. 1 is a view illustrating an example of a wearable device and a main device according to an embodiment.

Referring to FIG. 1, the wearable device 100 may be a device having a watch structure. The main device 200 may be a portable and mobile communication device such as a smart phone.

The wearable device 100 and the main device 200 may transmit and receive data through various schemes of wireless communications. For example, the wearable device 100 and the main device 200 may transmit and receive data according to at least one communication scheme among Wireless Fidelity (WiFi), BlueTooth (BT), Near Field Communication (NFC) and GPS. Alternatively, the data may be transmitted and received through a cellular communication (e.g, Long Term Evolution (LTE), LTE-Advanced (LTE-A), Code Division Multiple Access (CDMA), Wideband CDMA (WCDMA), Universal Mobile Telecommunications System (UMTS), Wireless broadband (WiBro), Global System for Mobile communication (GSM), and the like).

Since the data is transmitted and received between the wearable device 100 and the main device 200, the wearable device 100 and the main device 200 may be linked with each other. Hereinafter, a function, which may be provided through the link between the wearable device 100 and the main device 200, is referred to as a linked function. For example, data according to a sensor value measured by at least one sensor in the wearable device 100 may be transmitted to the main device 200, and the linked function may include various functions provided from the main device 200 using the transmitted data. As another example, information on an application executed by the main device 200 or installed in the main device 200 may be transmitted to the wearable device 100, and the linked function may include various functions provided from the wearable device 100 using the transmitted information. Alternatively, information or a control instruction related to an application executed by the main device 200 or installed in the main device 200 may be transmitted from the wearable device 100 to the main device 200, and the linked function may include a function operated according to the transmitted data or control instruction by the main device 200. In addition, information related to an application executed by the wearable device 100 or installed in the wearable device 100 may be transmitted to the main device 200, and the linked function may include a function operated according to the transmitted data by the main device 200. Alternatively, information or a control instruction related to an application executed by the wearable device 100 or installed in the wearable device 100 may be transmitted from the main device 200 to the wearable device 100, and the linked function may include a function operated according to the transmitted data or control instruction by the wearable device 100. The linked function may include at least one function among a call function, an SMS function, a schedule management function and/or a notification function (e.g., a notification function such as a message reception, a telephone call reception, and/or an updating) of the main device 200.

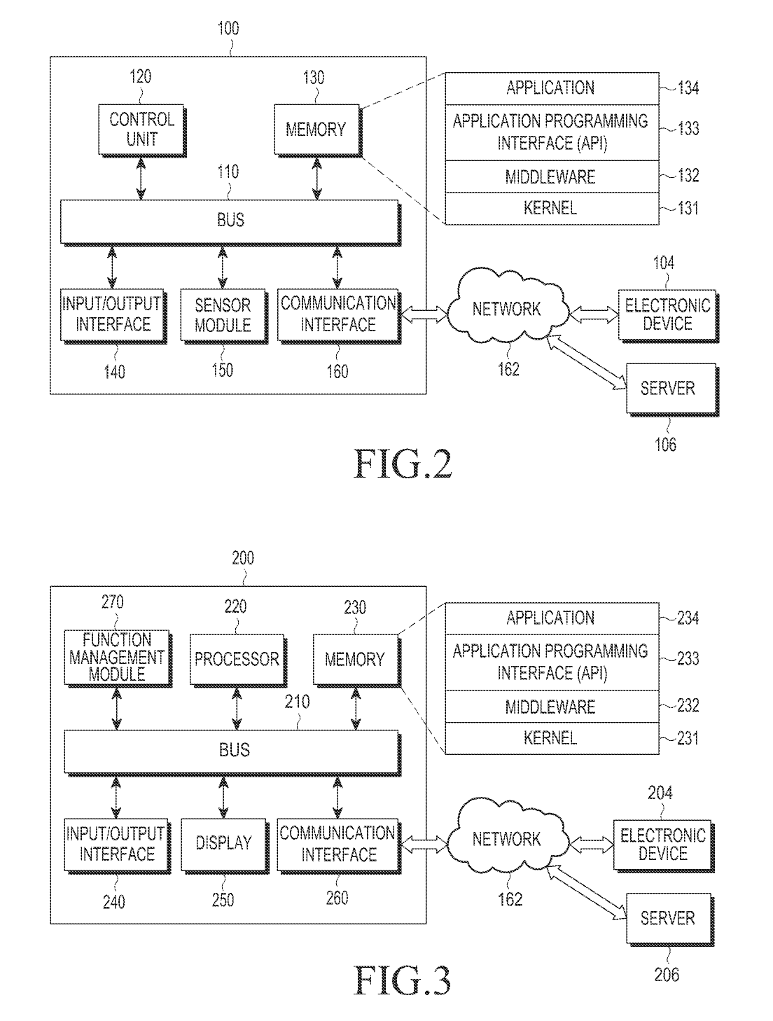

FIG. 2 illustrates a construction of the wearable device 100 according to various embodiments of the present disclosure.

Referring to FIG. 2, the wearable device 100 may include a bus 110, a control unit 120, a memory 130, an input/output interface 140, a sensor module 150 and a communication interface 160, but is not limited thereto.

The bus 110 may be a circuit connecting the components described above and transmitting a form of communication (e.g., a control message) between the components described above.

The control unit 120 may receive an instruction through, for example, the bus 110, from the above-mentioned other components (e.g., the memory 130, the input/output interface 140, the sensor module 150, the communication interface, and the like), decode the received instruction, and perform a calculation or a data process according to the decoded instruction.

The sensor module 150 may include at least one sensor. For example, the sensor module 150 may a contact sensor which may detect a contact-or-not for an object. In addition, the sensor module 150 may include a sensor which may collect the bio information of a user. For example, the sensor module 150 may include at least one among a heart beat sensor, a temperature measuring sensor, a pulse measuring sensor and a sound wave sensor. A movement recognition sensor may include at least one of a geomagnetic sensor, an acceleration sensor, a direction sensor and a gyro sensor.

The memory 130 may store a command or data received from the control unit 120 or other components (e.g., the input/output interface 140, the sensor module 150 and the communication interface 160) or may store a command or data generated by the control unit 120 or other components. The memory 130 may include programming modules, such as a kernel 131, middleware 132, an Application Programming Interface (API) 133 and an application 134. Each of the programming modules described above may be formed of software, firmware, and hardware, or a combination thereof.

The kernel 131 may control or manage system resources (e.g., the bus 110, the control unit 120, the memory 130, and the like), used for executing an operation or a function implemented in other programming modules, for example, the middleware 132, the API 133, or the application 134. Furthermore, the kernel 131 may provide an interface that enables the middleware 132, the API 133, or the application 134 to access an individual component of the wearable device 100 for control or management.

The middleware 132 may function as a relay so that the API 133 or the application 134 executes a communication with the kernel 131 to transmit and receive data to and from the kernel 131. Furthermore, in association with operation requests received from the application 134, the middleware 132 may execute a control (e.g., scheduling or load balancing) for an operation request, using, for example, a method of assigning, to at least one of the applications 134, a priority for use of a system resource (e.g., for example, the bus 110, the control unit 120, the memory 130, and the like) of the wearable device 100.

The API 133 is an interface used by the application 134 to control a function provided from the kernel 131 or the middleware 132, and may include, for example, at least one interface or function (e.g., a command) for a file control, a window control, an image processing, a character control, and the like.

According to various embodiments, the application 134 may include a Short Message Service (SMS)/Multimedia Messaging Service (MMS) application, an email application, a calendar application, an alarm application, a health care application (e.g., an application for measuring a quantity of exercise, blood sugar, and the like), an environment information application (e.g., an application for providing information on atmospheric pressure, humidity, temperature, and the like), and the like. Additionally or alternatively, the application 134 may be an application associated with exchanging information between the wearable device 100 and an external electronic device (e.g., an electronic device 104). The application related to the information exchange may include, for example, a notification relay application for transmitting and receiving specific information to an external electronic device or a device management application for managing an external electronic device.

For example, the notification relay application may include a function of transferring, to the external electronic device (e.g., the electronic device 104), notification information generated from other applications of the electronic device 100 (e.g., an SMS/MMS application, an e-mail application, a health management application, an environmental information application, and the like. Additionally or alternatively, the notification transmission application may, for example, receive notification information from an external electronic device (e.g. the electronic device 104) to provide the notification information to a user. The device management application may manage (e.g., install, delete, or update), for example, a function (e.g., turning on/off the external electronic device (or a few component) or adjusting brightness (or resolution) of a display) of at least a part of an external electronic device (e.g., the electronic device 104) that communicates with the wearable device 100, an application operated in the external electronic device, or a service (e.g., a call service or a message service) provided from the external electronic device.

In accordance with various embodiments of the present disclosure, the application 134 may include an application designated according to properties (e.g., a type of the electronic device) of an external electronic device (e.g., the electronic device 104). For example, when the external electronic device is an MP3 player, the application 134 may include an application related to reproduction of a music. Similarly, when the external electronic device is a mobile medical device, the application 134 may include an application related to a health care. In accordance with an embodiment, the application 134 may include at least one application designated to the wearable device 100 and an application received from an external electronic device (e.g., a server 106 or the electronic device 104).

According to an embodiment of the present disclosure, the memory 130 may store a reference value which may determine a use-or-not, that is, a use state for the wearable device 100 of the user. According to an embodiment of the present disclosure, the use state for the wearable device 100 may include a wear state and a non-wear state or a sleep state and a non-sleep state of the user.

The reference value may be information determining the wear state and the non-wear state of the user and information, which is a reference determining the sleep state and the non-sleep state of the user.

The reference value for the wear state or the non-wear state may be a sensor value. For example, the reference value may be a sensor value indicating a contact state of a sensor, which may detect a contact between the wearable device 100 and an external object. Alternatively, the reference value may be effective sensor values of each sensor, which may measure bio information (e.g., a heart beat number, a pulse number, a temperature and a pulse).

The reference value for the sleep state or the non-sleep state may be a sensor value. For example, the reference value may be sensor values corresponding to each sensor which may measure bio information of the user and determine the sleep state.

In addition, according to an embodiment of the present disclosure, the memory 130 may store information on a function of the wearable device 100, of which the execution is limited in the non-wear state or the sleep state.

The input/output interface 140 may transfer a command or data input from the user through an input/output device (e.g., a sensor, a keyboard or a touch screen) to the control unit 120, the memory 130 or the communication interface 160 through, for example, the bus 110. For example, the input/output interface 140 may provide, to the control unit 120, data with respect to a touch of a user input through a touch screen. Also, the input/output interface 140 may output a command or data, which has been received from the control unit 120, the memory 130 or the communication interface 160 to an input/output device (e.g., a speaker or a display) through, for example, the bus 110. For example, the input/output interface 140 may output voice data processed through the control unit 120 to the user through the speaker.

The communication interface 160 may connect a communication between the wearable device 100 and an external electronic device (e.g., the electronic device 104 or the server 106). For example, the communication interface 160 may be connected to the network 162 through a wireless communication or a wired communication, and may communicate with an external device. The wireless communication may include at least one of, for example, Wifi, BT, NFC, GPS and cellular communication (e.g., LTE, LTE-A, CDMA, WCDMA, UMTS, WiBro, GSM and the like). The wired communication may include at least one of, for example, a Universal Serial Bus (USB), a High Definition Multimedia Interface (HDMI), a Recommended Standard 232 (RS-232), and a Plain Old Telephone Service (POTS).

The electronic device 104 may be, for example, the main device 200.

In accordance with an embodiment, the network 162 may be a communication network. The communication network may include at least one of a computer network, Internet, Internet of things, and a telephone network. In accordance with an embodiment, a protocol (e.g., a transport layer protocol, a data link layer protocol, or a physical layer protocol) for the communication between the wearable device 100 and the external device may be supported by at least one of the application 134, the application programming interface 133, the middleware 132, the kernel 131, and the communication interface 160.

The control unit 120 may process at least a part of the information obtained from the other components (e.g., the memory 130, the input/output interface 140, the communication interface 160, the sensor module 150 and the like) and provide this information to the user through various methods.

According to an embodiment, the control unit 120 may periodically determine the use-or-not of the user for the wearable device 100. That is, the control unit 120 may periodically determine the wear state of the wearable device 100 or the sleep state of the user. When the control unit 120 determines that the non-wear state of the wearable device 100 or the sleep state of the user, the control unit 120 may limit an execution of a part of the functions of the wearable device 100. In addition, the control unit 120 may report a non-use state of the wearable electronic device, that is, the non-wear state or the sleep state, to the main device 200.

When the non-wear state or the sleep state is maintained for a predetermined period, the control unit 120 may disconnect a communication connected to the main device 200. The predetermined period may be longer than a period when the wear-or-not or the sleep-or-not is determined. Thus, when the wear state or the non-sleep state is detected before the predetermined period is elapsed; the control unit 120 may restore the functions of which operations are limited to a normal state. In addition, the control unit 120 may report the wear state or the non-sleep state to the main device 200.

After the control unit 120 disconnects the communication connected to the main device 200, the control unit 120 may periodically monitor the wear-or-not or the sleep-or-not. When the wearable device 100 is determined as the wear state or the user is determined to be in the non-sleep state, the control unit 120 may connect the communication to the main device 200 again and release the limit such that the functions of which the operations are limited are normally operated.

According to another embodiment, the wearable device 100 may communicate with the main device 200 through a plurality of communication schemes. For example, the wearable device 100 may be connected to the main device 200 through a plurality of short range wireless communications. Alternatively, the wearable device 100 may be connected to the main device 200 through any short range communication, and may communicate with the main device 200 through a cellular communication scheme. According to an embodiment, the plurality of communication schemes may be classified as a comparative high rank communication and a comparative low rank communication according to a supportable communication range. For example, the low rank communication may be a communication scheme of which a supportable communication range is comparatively narrow among the above-mentioned plurality communication schemes. For example, in cellular communication, WiFi, BT, and NFC, the highest communication may be the cellular communication, and the least communication may be the NFC. Also, the WiFi may be a high rank communication compared to the BT. For example, the high rank communication may be the cellular communication, and the low rank communication of the cellular communication may be the WiFi, the BT, and the NFC.

According to an embodiment, in a state in which the wearable device 100 may communicate with the main device 200 through the plurality of communication schemes, a connection of the low rank communication is disconnected without the request of the user, and the control unit 120 may determine the wear state of the wearable device 100. For example, in a state in which the wearable device 100 and the main device 200 are connected with each other through BT and the cellular communication is possible, the BT connection may be disconnected. As a result of the determining, when the wearable device 100 is determined as the non-wear state, the control unit 120 may report the non-wear state to the main device 200 through the high rank communication. In addition, the control unit 120 may limit operations of some functions of the wearable device 100.

As the result of the determining, when the wearable device 100 is determined to be in the wear state, the control unit 120 may report the wear state to the main device 200 through the high rank communication. Therefore, the wear state report may include information indicating that the low rank communication is disconnected without the request of the user and the wearable device 100 is in the wear state.

Although the low rank communication, for example, the BT, is disconnected, when the wearable device 100 is detected as being the wear state, the wearable device 100 may have been lost or stolen. Therefore, when the main device 200 receives such a wear state report, the main device 200 may output a message suggesting to the user that there is a possibility that the wearable device 100 is lost.

FIG. 3 is a view illustrating a construction of the main device 200 according to an embodiment of the present disclosure.

Referring to FIG. 3, the main device 200 may include a bus 210, a processor 220, a memory 230, an input/output interface 240, a display 250, a communication interface 260, and a function management module 270, but is not limited thereto.

The bus 210 may be a circuit connecting the above described components and transferring a form of communication (e.g., a control message) between the above described components.

The processor 220 may, for example, receive a command from other elements (e.g., the memory 230, the input/output interface 240, the display 250, the communication interface 260, the function management module 270, and the like), through the bus 210, may decrypt the received command, and may execute operation or data processing based on the decrypted command.

The display 250 may display various information (e.g., multimedia data, text data and the like) and images to the user.

The memory 230 may store a command or data received from the processor 220 or the other components (e.g., the input/output interface 240, the display 250, the function management module 270, or the communication interface 260) or a command or data generated by the processor 220 or the other components. The memory 230 may include programming modules, for example, a kernel 231, a middleware 232, an API 233, an application 234, and the like. Each of the programming modules described above may be formed of software, firmware, and hardware, or a combination thereof.

The kernel 231 may control or manage system resources (e.g., the bus 210, the processor 220, the memory 230, and the like), used for executing an operation or a function implemented in other programming modules, for example, the middleware 232, the API 233, or the application 234. Furthermore, the kernel 231 may provide an interface that enables the middleware 232, the API 233, or the application 234 to access an individual component of the main device 200 for control or management.

The middleware 232 may function as a relay so that the API 233 or the application 234 executes a communication with the kernel 231 to transmit and receive data to and from the kernel 231. Furthermore, in association with operation requests received from the application 234, the middleware 232 may execute a control (e.g., scheduling or load balancing) for an operation request, using of, for example, a method of assigning, to at least one of application 234, a priority for use of a system resource (e.g., the bus 210, the processor 220, the memory 230, and the like) of the main device 200.

The API 233 is an interface used by the application 234 to control a function provided from the kernel 231 or the middleware 232, and may include, for example, at least one interface or function (e.g., a command) for a file control, a window control, an image processing, a character control, etc.

According to various embodiments of the present disclosure, the application 234 may include a SMS/MMS application, an email application, a calendar application, an alarm application, a health care application (e.g., an application for measuring a quantity of exercise, blood sugar, and the like), an environment information application (e.g., an application for providing information on atmospheric pressure, humidity, temperature, and the like), and the like. Additionally or alternatively, the application 234 may be an application associated with exchanging of information between the wearable device 100 and an external electronic device (e.g., an electronic device 204). The application related to the information exchange may include, for example, a notification transmission application for transmitting and receiving predetermined information to and from an external electronic device or a device management application for managing the external electronic device.

For example, the notification transmission application may include a function of transferring, to the external electronic device (e.g., the electronic device 204), notification information generated from other applications (e.g., an SMS/MMS application, an e-mail application, a health management application, an environmental information application, and the like) of the main device 200. Additionally or alternatively, the notification transmission application may, for example, receive the notification information from an external electronic device (e.g. the electronic device 204) to provide the notification information to a user. The device management application may manage (e.g., install, delete, or update), for example, a function (e.g., turning on/off the external electronic device (or a few component) or adjusting brightness (or resolution) of a display) of at least a part of an external electronic device (e.g., the electronic device 204) that communicates with the main device 200, an application operated in the external electronic device, or a service (e.g. a call service or a message service) provided from the external electronic device.

In accordance with various embodiments, the application 234 may include an application designated according to properties (e.g., a type of the electronic device) of an external electronic device (e.g., the electronic device 204). For example, when the external electronic device is an MP3 player, the application 234 may include an application related to a reproduction of a music. Similarly, when the external electronic device is a mobile medical device, the application 234 may include an application related to a health care. In accordance with an embodiment, the application 234 may include at least one of applications designated to the main device 200 or an application received from an external electronic device (e.g. a server 206 or the electronic device 204).

According to an embodiment, when the non-wear state or the sleep state is reported from the wearable device 100 to the memory, the memory 230 may store information on a function of the main device 200, of which an execution is limited.

The input/output interface 240 may transfer a command or data input from the user through an input/output device (e.g., a sensor, a keyboard or a touch screen) to the processor 220, the memory 230, the function management module 270 or the communication interface 260 through, for example, the bus 210. For example, the input/output interface 240 may provide, to the processor 220, data with respect to a touch of a user input through a touch screen. Furthermore, the input/output interface 240 may output a command or data received through, for example, the bus 210, from the processor 220, the memory 230, the communication interface 260, or the function management module 270 through an input/output device (e.g., a speaker or display). For example, the input/output interface 240 may output voice data processed through the processor 220 to the user through the speaker.

The communication interface 260 may connect a communication between the wearable device 100 and an electronic device (e.g., the electronic device 204 or the server 206). For example, the communication interface 260 may be connected to the network 162 through a wireless communication or a wired communication, and may communicate with an external device. The wireless communication may include at least one of, for example, Wifi, BT, NFC, GPS and cellular communication (for LTE, LTE-A, CDMA, WCDMA, UMTS, WiBro, GSM and the like). The wired communication may include at least one of, for example, a USB, a HDMI, a RS-232, and a POTS.

The electronic device 204 may be the wearable device 100.

In accordance with an embodiment, the network 162 may be a communication network. The communication network may include at least one of a computer network, Internet, Internet of things, and a telephone network. In accordance with an embodiment, a protocol (e.g., a transport layer protocol, a data link layer protocol, or a physical layer protocol) for the communication between the main device 200 and the external device may be supported by at least one of the application 234, the application programming interface 233, the middleware 232, the kernel 231, and the communication interface 260.

The function management module 270 may process at least some information obtained from the other components (e.g., the memory 230, the input/output interface 240, the communication interface 260, the display 250 and the like) and provide this to the user in various schemes.

According to an embodiment, when the function management module 270 receives the report for the non-wear state or the sleep state, the function management module 270 may limit the execution of a part of functions. When the function management module 270 receives the report for the wear state or the non-sleep state from the wearable device 100, the function management module 270 may restore the function of the main device 200, of which an operation has been limited to a normal state.

The function management module 270 may disconnect the communication to the wearable device 100 or connect the communication to the wearable device 100 again according to a request of the wearable device 100. When the communication to the wearable device 100 is connected again, the function management module 270 may restore the function of the main device 200 to the normal state.

According to an embodiment, in a state in which the main device 200 may communicate with the wearable device 100 in a plurality of communication schemes, the non-wear state is reported from the wearable device 100 to the main device 200 through the high rank communication, the function management module 270 may limit the operations of some functions of the wearable device 100.

When the function management module 270 receives the wear state report including information on a disconnection of the low rank communication without a user's request and information on the wear state through the high rank communication, the function management module 270 may output a message suggesting a loss probability of the wearable device 100 to the user. In addition, the function management module 270 may transfer a locking command to the wearable device 100 according to the request of the user. Furthermore, the function management module 270 may request position information to the wearable device 100.

When the wearable device 100 receives the locking command, the wearable device 100 may set a locking state thereto such that another user cannot use the wearable device 100. In addition, the wearable device 100 may transmit a current position to the main device 200 according to current position information request.

Meanwhile, according to another embodiment, the function management module 270 may be a construction in the processor 220.

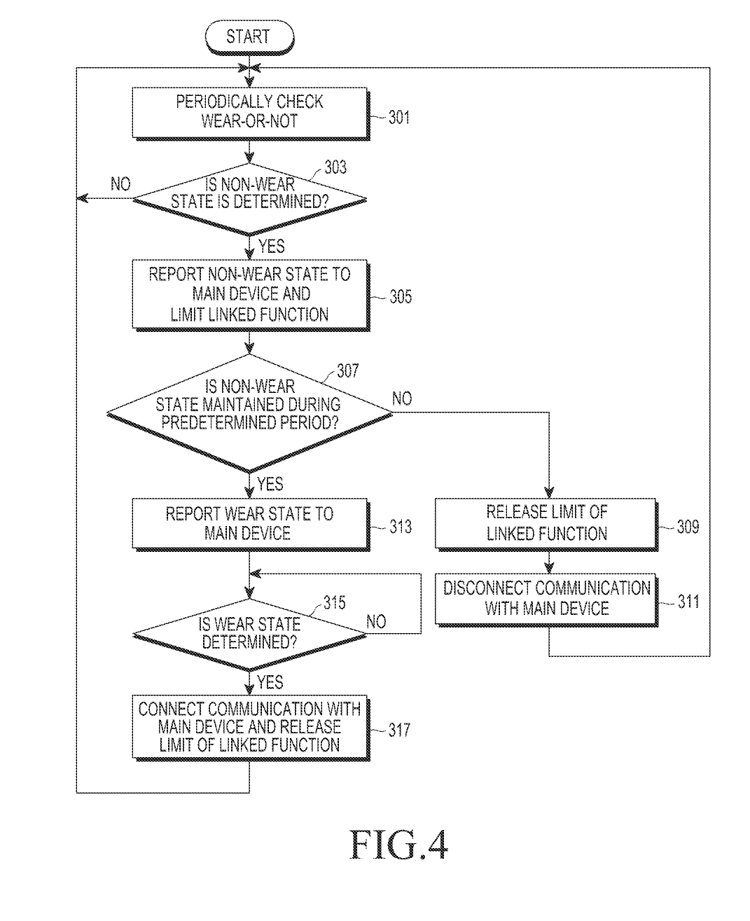

Hereinafter, according to an embodiment, operation processes of the wearable device 100 and the main device 200 constructed as described above will be described with reference to FIGS. 4 to 8.

FIG. 4 is a view illustrating the operation process of the wearable device 100 according to the wear-or-not state of the user for the wearable device 100 according to an embodiment of the present disclosure.

Referring to FIG. 4, in operation 301, the control unit 120 of the wearable device 100 may periodically determine the wear-or-not of the wearable device 100. The wear-or-not of the wearable device 100 may be determined using a sensor value of at least one sensor in the sensor module 150. For example, the wear-or-not of the wearable device 100 may be determined by comparing a sensor value of a sensor which may detect a contact with an external object with a corresponding reference value stored in the memory 130. Alternatively, the wear-or-not of the user for the wearable device 100 may be determined using a sensor value of a sensor which may measure bio information. The monitoring for the wear-or-not may be continuously performed regardless of the determination of the wear state or the non-wear state.

In operation 303, the wearable device 100 is determined as the non-wear state, in operation 305, the control unit 120 may transmit the non-wear state report message to the main device 200 through the communication interface 160. According to an embodiment of the present disclosure, the main device 200 receiving the non-wear state report message may limit the part of the function thereof. For example, the main device 200 may limit functions related to the wearable device 100.

In addition, the control unit 120 may limit the execution of some functions of the wearable device 100. For example, the control unit 120 may limit the linked function by stopping data transmission and reception between the wearable device 100 and the main device 200. Alternatively, the control unit 120 may limit the linked function according to each application. In this case, an application of which a linked function is limited may be selected by a user in advance.

After the control unit 120 limits the part of the function of the wearable device 100, the control unit 120 may periodically monitor the wear-or-not for the wearable device 100.

In operation 307, the control unit 120 may determine whether the non-wear state of the wearable device 100 is maintained for a predetermined period. When the non-wear state is maintained, the control unit 120 may perform operation 313, and when the non-wear state is not maintained, the control unit 120 may perform operation 309. That is, when the wear state is detected before the predetermined period is not elapsed, in operation 309, the control unit 120 may transmit the wear state report message to the main device 200. According to an embodiment, the main device 200 receiving the wear state report message may restore limited some functions to the normal state.

In operation 311, the control unit 120 may restore the some functions limited in operation 305, for example, the linked function to the normal state. That is, the control unit 120 may release the limit of the linked function.

Meanwhile, in operation 307, when the wear state is not detected for the predetermined period, in operation 313, the control unit 120 may disconnect the communication with the main device 200. According to another embodiment, the control unit 120 may display a message which guides a disconnection before disconnecting the communication with the main device 200. When a disconnection stop request is not input from the user within a predetermined period, the communication with the main device 200 may be disconnected.

According to another embodiment of the present disclosure, after the disconnection of the communication with the main device 200, the control unit 120 may additionally limit the function of the wearable device 100. For example, the control unit 120 may stop operations of remaining sensors except a sensor used for detecting the wear state of the wearable device 100. Alternatively, the control unit 120 may turn off power of the display of the wearable device 100.

After the communication is disconnected, the control unit 120 may periodically determine the wear-or-not of the wearable device 100. Thus, in operation 315, the wear state is determined, in operation 317, the control unit 120 may connect the communication with the main device 200 again and restore the limited function to the normal state. For example, the control unit 120 may release the limit of the linked function.

When the communication with the wearable device 100 is connected again, the main device 200 may restore the limited functions to the normal state.

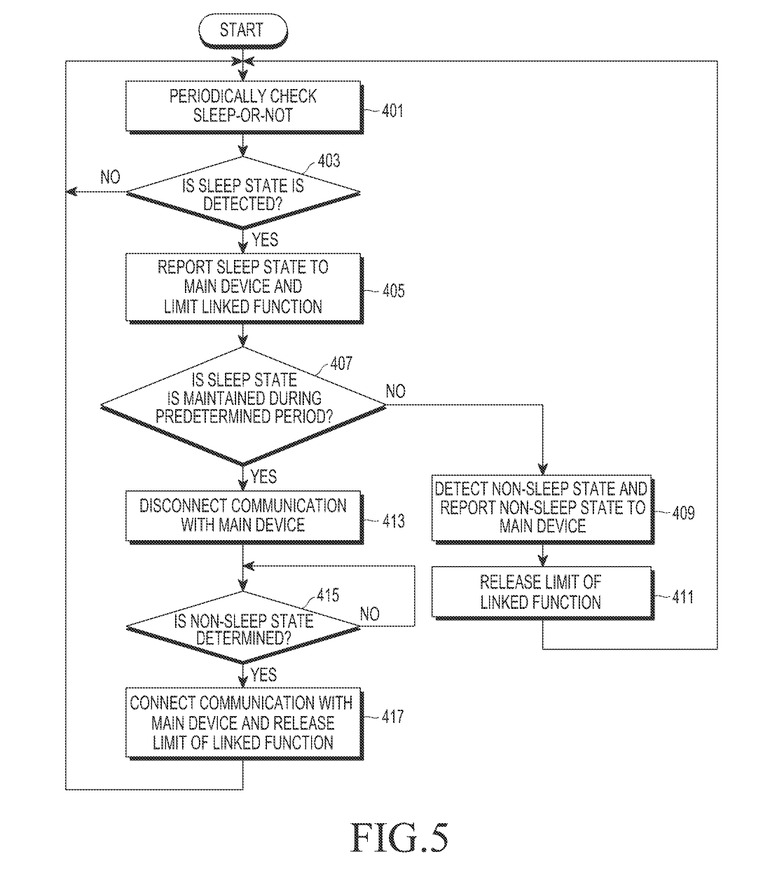

FIG. 5 is a view illustrating an operation process of a wearable device according to a sleep-or-not of a user wearing the wearable device according to an embodiment of the present disclosure. In an embodiment shown in FIG. 5, it may be assumed that the user wears the wearable device.

Referring to FIG. 5, in operation 401, the control unit 120 of the wearable device 100 may periodically determine the sleep-or-not of user. The sleep-or-not of the user may be determined using a sensor value of at least one sensor in the sensor module 150. For example, the sleep-or-not of the user may be determined by comparing a sensor value of a sensor which may measure bio information with a corresponding reference value stored in the memory 130. Alternatively, the sleep-or-not of the user may be determined by comparing a sensor value of a movement recognition sensor with a corresponding reference value stored in the memory 130. The monitoring for the sleep-or-not may be continuously performed regardless of the determination of the sleep state or the non-sleep state.

In operation 403, the user is determined as the sleep state, in operation 405, the control unit 120 may transmit the sleep state report message to the main device 200 through the communication interface 160. According to an embodiment of the present disclosure, the main device 200 receiving the sleep state report message may limit the part of the function thereof. For example, the main device 200 may limit the functions related to the wearable device 100.

In addition, the control unit 120 may limit the execution of some functions of the wearable device 100. For example, the control unit 120 may limit the linked function by stopping the data transmission and reception between the wearable device 100 and the main device 200. Alternatively, the control unit 120 may limit the linked function according to each application. In this case, an application of which a linked function is limited may be selected by a user in advance.

After the control unit 120 limits the part of the function of the wearable device 100, the control unit 120 may periodically monitor the sleep-or-not for the wearable device 100.

In operation 407, the control unit 120 may determine whether the sleep state is maintained for a predetermined period. When the sleep state is maintained, the control unit 120 may perform operation 413, and when the sleep state is not maintained, the control unit 120 may perform operation 409. That is, when the non-sleep state is detected before the predetermined period is not elapsed, in operation 409; the control unit 120 may transmit the non-sleep state report message to the main device 200. According to an embodiment of the present disclosure, the main device 200 receiving the non-sleep state report message may restore limited some functions to the normal state.

In operation 411, the control unit 120 may restore some functions limited in operation 405, for example, the linked function to the normal state. That is, the control unit 120 may release the limit of the linked function.

Meanwhile, in operation 407, when the non-sleep state is not detected for the predetermined period, in operation 413, the control unit 120 may disconnect the communication with the main device 200. According to another embodiment of the present disclosure, the control unit 120 may display the message which guides the disconnection before disconnecting the communication with the main device 200. When a disconnection stop request is not input from the user within the predetermined period, the communication with the main device 200 may be disconnected.

According to another embodiment of the present disclosure, after the disconnection of the communication with the main device 200, the control unit 120 may additionally limit the function of the wearable device 100. For example, the control unit 120 may turn off power of the display of the wearable device 100.

After the communication is disconnected, the control unit 120 may periodically determine the sleep-or-not of the user. Thus, in operation 415, the non-sleep state is determined, in operation 417, the control unit 120 may connect the communication with the main device 200 again and restore the limited function to the normal state. For example, the control unit 120 may release the limit of the linked function.

When the communication with the wearable device 100 is connected again, the main device 200 may restore the limited functions to the normal state.

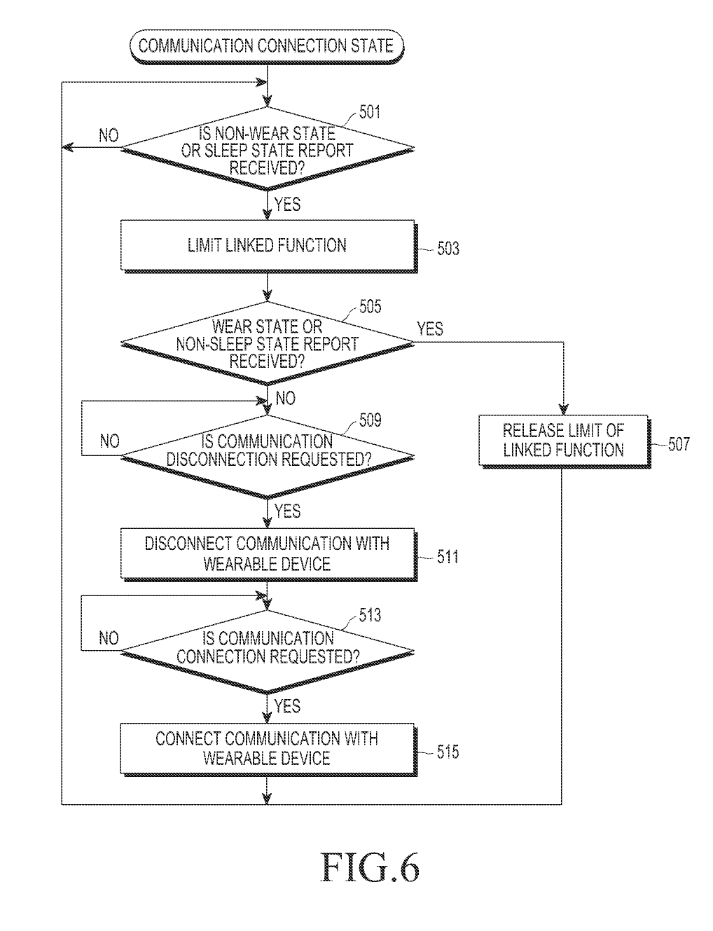

FIG. 6 is a view illustrating the operation process of a main device according to an embodiment of the present disclosure. In an embodiment shown in FIG. 6, it may be assumed that the communication between the main device and a wearable device is connected.

Referring to FIG. 6, in operation 501, when the function management module 270 of the main device 200 receives the non-wear state report message or the sleep state report message, in operation 503, the function management module 270 of the main device 200 may limit a part of the function of the main device 200. For example, the linked function related to the wearable device 100 may be limited. The function management module 270 may limit the linked function by stopping the data transmission and reception between the wearable device 100 and the main device 200. Alternatively, the control unit 120 may limit the linked function according to each application. In this case, an application of which a linked function is limited may be selected by a user in advance.

In a state in which the function related to the wearable device 100 is limited, when the wear state report message or the non-sleep state report message is received (i.e., operation 505), in operation 507, the function management module 270 may restore the limited function to the normal state. That is, the function management module 270 may release the limited linked function.

Meanwhile, in operation 509, when a communication disconnection request is received from the wearable device 100, in operation 511, the function management module 270 may disconnect the communication with the wearable device 100.

After the communication with the wearable device 100 is disconnected, in operation 513, a communication connection request is received from the wearable device 100, in operation 515, the function management module 270 may connect the communication with the wearable device 100, and in operation 503, may restore the function limited in operation 503 to the normal state.

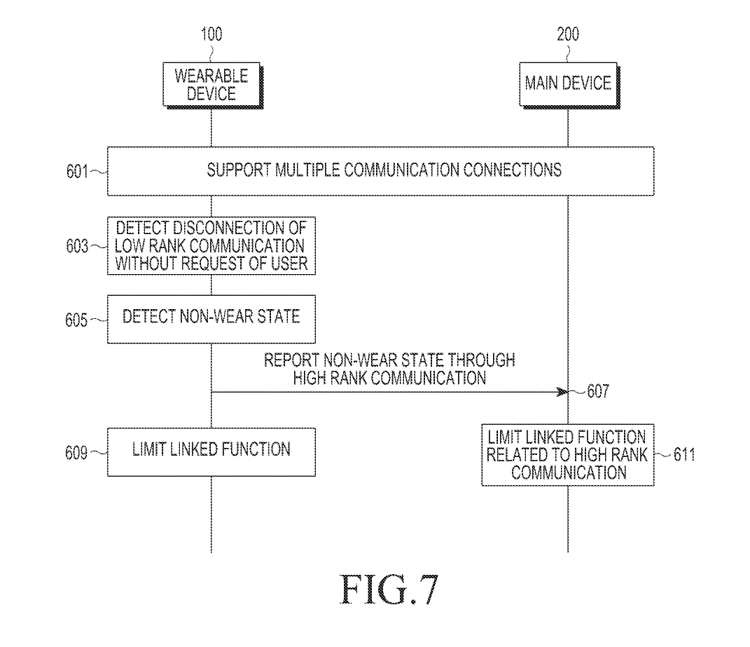

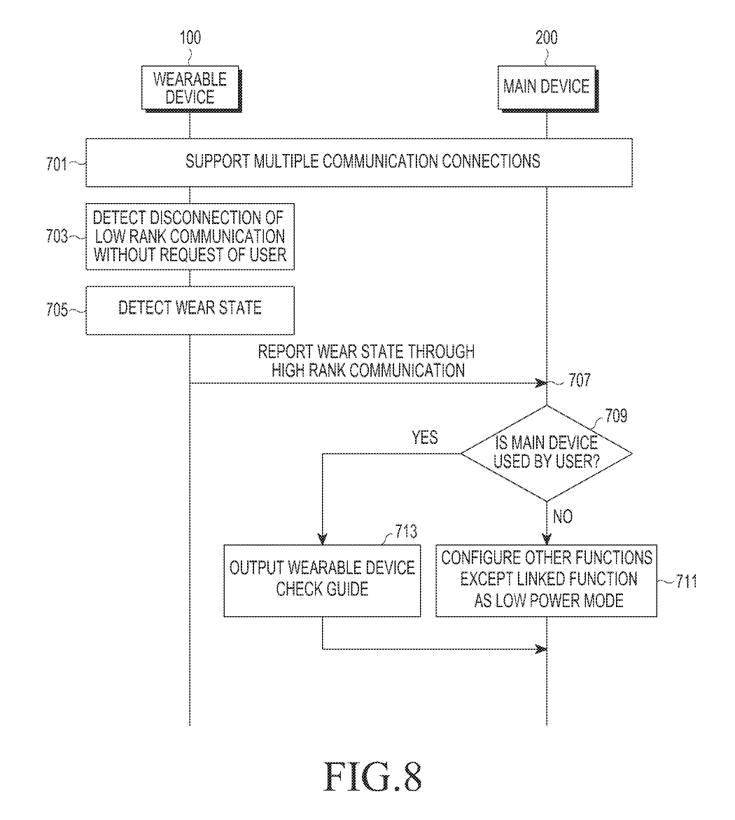

FIGS. 7 and 8 are views illustrating operation processes of a wearable device and a main device when a low rank communication is disconnected in a state in which the communication between the wearable device and the main device through a plurality of communication schemes is possible according to an embodiment of the present disclosure.

Referring to FIG. 7, as shown in operation 601, in the mutual communication between the wearable device 100 and the main device 200, multiple communication connections (i.e., the plurality of communication schemes) may be supported. For example, the wearable device 100 and the main device 200 may be connected with each other through the BT communication, and the cellular communication may be possible between the wearable device 100 and the main device 200.

In such a state, in operation 603, when the control unit 120 detects a disconnection of the low rank communication (e.g., the BT communication) without a disconnection request of a user, the control unit 120 may determine the wear-or-not of the wearable device 100. As a result of the determine of the wear-or-not of the wearable device 100, in operation 605, when the non-wear state is detected, in operation 607, the control unit 120 may transmit the non-wear state report message to the main device 200 through the high rank communication (e.g., the cellular communication). At this time, the non-wear state report message may include information which indicates an abnormal disconnection of the low rank communication. In operation 609, the control unit 120 may limit the linked function by stopping data transmission and reception through a high rank communication with the main device 200.

Meanwhile, in operation 611, the main device 200 receiving the non-wear state report message may limit the linked function related to the high rank communication by stopping the data transmission and reception through a high rank communication with the wearable device 100.

Referring to FIG. 8, as shown in operation 701, in the mutual communication between the wearable device 100 and the main device 200, multiple communication connections (i.e., the plurality of communication schemes) may be supported. For example, the wearable device 100 and the main device 200 may be connected with each other through the WiFi communication, and the cellular communication may be possible between the wearable device 100 and the main device 200.

In such a state, in operation 703, when the control unit 120 detects a disconnection of the low rank communication (e.g., the WiFi communication) without the disconnection request of the user, the control unit 120 may determine the wear-or-not of the wearable device 100. As a result of the determine of the wear-or-not of the wearable device 100, in operation 705, when the wear state is detected, in operation 707, the control unit 120 may transmit the wear state report message to the main device 200 through the high rank communication (e.g., the cellular communication). At this time, the wear state report message may include information that indicates the abnormal disconnection of the low rank communication.

Meanwhile, in operation 709, the function management module 270 receiving the wear state report message may determine whether the main device 200 is used by the user. For example, the function management module 270 may determine that the main device 200 is used by the user when the main device 200 provides a call function or a user's input is detected within a predetermined period. Alternatively, the function management module 270 may determine that the main device 200 is used by the user when a specific application such as a music reproduction application or a video reproduction application is driven.

In operation 709, when it is determined that the main device 200 is used by the user, in operation 713, the function management module 270 may output a message which guides a determination of the wearable device to the user.

In operation 711, when it is determined that the main device 200 is not used by the user, the function management module 270 may configure other functions except the liked function as a low power mode by stopping the data transmission and reception through the high rank communication with the wearable device 100.

The term “module” used in the present disclosure may refer to, for example, a unit including one or more combinations of hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments of the present disclosure, at least some of the devices (e.g., modules or functions thereof) or the method (e.g., operations) according to the present disclosure may be implemented by a command stored in a computer-readable storage medium in a programming module form. When he command is executed by one or more processors (e.g., the processor 210), the one or more processors may execute a function corresponding to the command. The computer-readable storage medium may be, for example, the memory 230. At least a part of the programming module may be implemented (e.g., executed) by, for example, the processor 210. At least a part of the programming module may include, for example, a module, a program, a routine, a set of instructions and/or a process for performing one or more functions.

The computer-readable recording medium may include magnetic media such as a hard disk, a floppy disk, and a magnetic tape, optical media such as a Compact Disc Read Only Memory (CD-ROM) and a DVD, magneto-optical media such as a floptical disk, and hardware devices specially configured to store and perform a program instruction (e.g., programming module), such as a Read Only Memory (ROM), a Random Access Memory (RAM), a flash memory and the like. In addition, the program instructions may include high class language codes, which may be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of managing a function of a wearable electronic device, the method comprising:
determining a wear-or-not of a user for the wearable electronic device; and
limiting at least one linked function using data transmitted and received to and from another electronic device, when the determining of the wear-or-not is determined as a non-wear state.

2. The method of claim 1, wherein the at least one linked function is limited according to a stop of the data transmission and reception to and from the other electronic device.

3. The method of claim 1, further comprising:
disconnecting a communication with the other electronic device, when the non-wear state is maintained for a determined period.

4. The method of claim 1, further comprising:
transmitting a report message which reports the non-wear state to the other electronic device.

5. The method of claim 1, further comprising:
releasing the limit for the at least one linked function when a wear state for the wearable electronic device is determined within a determined period after the non-wear state is determined.

6. The method of claim 1, wherein the wear-or-not of the user for the wearable electronic device is determined using a sensor value of a sensor in the wearable electronic device.

7. The method of claim 1, further comprising:
determining a sleep-or-not of the user when the determining of the wear-or-not is determined as a wear state after the result of the determining; and
limiting the at least one linked function when the determining the sleep-or-not is determined as a sleep state.

8. The method of claim 7, further comprising:
disconnecting a communication with the other electronic device when the sleep state is maintained for a determined period.

9. The method of claim 7, further comprising:
transmitting a report message which reports the sleep state to the other electronic device.

10. The method of claim 7, further comprising:
releasing the limit for the at least one linked function when a non-sleep state of the user is determined within a determined period after the sleep state is determined.

11. The method of claim 7, wherein the sleep-or-not of the user is determined using a sensor value of a sensor in the wearable electronic device.

12. The method of claim 4,
wherein the determining of the wear-or-not of the user for the wearable electronic device comprises determining the wear-or-not of the user for the wearable electronic device when a low rank communication is disconnected in a state in which a plurality of communication schemes are possible between the wearable electronic device and the other electronic device, and
wherein the low rank communication is a communication scheme of which a supportable communication range is comparatively narrow among the plurality of communication schemes.

13. The method of claim 10, wherein the non-wear state report message is transmitted to the other electronic device through a high rank communication.

14. A wearable electronic device comprising:
at least one sensor; and
a control unit configured to:
determine a wear-or-not of a user for the wearable electronic device, using a sensor value of the sensor, and
limit at least one linked function using data transmitted and received to and from another electronic device, when the determining of the wear-or-not is determined as a non-wear state.

15. The wearable electronic device of claim 14, wherein the at least one linked function is limited according to a stop of the data transmission and reception to and from the other electronic device.

16. The wearable electronic device of claim 14, wherein the control unit is further configured to disconnect a communication with the other electronic device, when the non-wear state is maintained for a determined period.

17. The wearable electronic device of claim 14, wherein the control unit is further configured to transmit a report message which reports the non-wear state to the other electronic device.

18. The wearable electronic device of claim 14, wherein the control unit is further configured to release the limit for the at least one linked function when a wear state for the wearable electronic device is determined within a determined period after the non-wear state is determined.

19. The wearable electronic device of claim 14, wherein the control unit is further configured to:
determine a sleep-or-not of the user when the determining of the wear-or-not is determined as a wear state after the result of the determining, and
limit the at least one linked function when the determining the sleep-or-not is determined as a sleep state.

20. The wearable electronic device of claim 19, wherein the control unit is further configured to disconnect a communication with the other electronic device when the sleep state is maintained for a predetermined period.

21. The wearable electronic device of claim 19, wherein the control unit is further configured to transmit a report message which reports the sleep state to the other electronic device.

22. The wearable electronic device of claim 19, wherein the control unit is further configured to release the limit for the at least one linked function when a non-sleep state of the user is determined within a predetermined period after the sleep state is determined.

23. The wearable electronic device of claim 17,
wherein the control unit is further configured to determine the wear-or-not of the user for the wearable electronic device when a low rank communication is disconnected in a state in which a plurality of communication schemes are possible between the wearable electronic device and the other electronic device, and
wherein the low rank communication is a communication scheme of which a supportable communication range is comparatively narrow among the plurality of communication schemes.

24. The wearable electronic device of claim 22, wherein the non-wear state report message is transmitted to the other electronic device through a high rank communication.

25. The wearable electronic device of claim 23, wherein the determining of the wear-or-not of the user for the wearable electronic device when the low rank communication is disconnected occurs when the low rank communication is disconnected by other than a user request.
